(19) United States
(12) Patent Application Publication
(10) Pub. No.: US 2016/0189157 A1
(43) Pub. Date: Jun. 30, 2016

(54) CARD LESS AND ATM LESS MONEY WITHDRAW / DEPOSIT

(71) Applicants: SRINIVAS NAGA BAVIRISETTY, NEWARK, DE (US); JYOSHNA DURGA KALYANI BAVIRISETTY, NEWARK, DE (US)

(72) Inventors: SRINIVAS NAGA BAVIRISETTY, NEWARK, DE (US); JYOSHNA DURGA KALYANI BAVIRISETTY, NEWARK, DE (US)

(21) Appl. No.: 14/807,395

(22) Filed: Jul. 23, 2015

Related U.S. Application Data
(60) Provisional application No. 62/028,279, filed on Jul. 23, 2014.

(51) Int. Cl. G06Q 20/40

(52) U.S. Cl. CPC G06Q 20/4012; G06Q 20/401

(57) ABSTRACT

A method for completing a transaction based on Card-less and ATM less is provided. The system embodying the method may be operatively connected to at least one server comprising a plurality of customer, merchants and banks, where in each customer profile comprises payment account information and at least one corresponding verified customer image, and or at least one corresponding device to securely authenticate payment if necessary. The payment account information comprises at least one payment card and or bank account associated with a pin number. At least one server may be configured to execute a payment authorization module and an authentication module comprising the following: receiving a request to authorize the transaction from the card/bank account of the customer to the merchant, or initiating request to authorize the transaction from the card/bank account of the customer from the merchant, where in the request may include a pin number based on the preferences of the customer; verifying whether the putative transaction details along with the pin number and details with the server are a match; transmitting customer validation info to the merchant; and generating in response to the match, a request of customer verification from the merchant.

### CROSS-REFERENCE TO RELATED APPLICATIONS

N/A

### BACKGROUND OF THE INVENTION

1. Field of the Invention

The present invention relates to ATM-less cash management authorization system for consumers to withdraw and deposit cash at in locations irrespective to a bank or ATM location.

2. Description of Related Art

Almost every citizen is holding a banking account to save the money. Also almost all the account holders are holding debit cards to withdraw the money from Bank/ATM. ATM became a very common machine to get the money after banking hours. Even during the banking hours most of the people are going to ATM's if it is not required a banking premises.

Customers/users can get the money from banking account with some of these following ways: Visiting account holding bank Visiting the bank within the network/visiting bank ATM/visiting other ATM with in network etc. In this customers have to find the bank/bank branch/network branch/bank ATM/network ATM or other ATM available. Banks has to maintain ATM machine to support the customer needs. Also some of the locations require the premises.

Regarding depositing money, this is bit more complicated than withdraw, since it requires bank/deposit support ATM as mandatory.

### BRIEF SUMMARY OF THE INVENTION

In one embodiment an ATM-less cash management authorization system is provided, comprising at least one server comprising a plurality of customers, a plurality of merchants and a plurality of banks; the plurality of customers including a customer profile for each customer, the customer profile comprising a payment account data and at least one corresponding verified customer image, and at least one corresponding device to securely authenticate payment; the payment account data comprising at least one payment card and at least one bank account associated with a pin number; the at least one server configured to execute a payment authorization module and an authentication module comprises the following: receiving a request to authorize the transaction from the at least one payment card and at least one bank account of the plurality of customers to the plurality of merchants.

In some embodiments, the at least one server configured to execute a payment authorization module and an authentication module comprises the following: initiating a request to authorize the transaction from the at least one payment card and at least one bank account of the plurality of customers to the plurality of merchants, wherein the request may include a pin number based on a set of preferences of the plurality of customers. In another embodiment, the system further comprises a step of verifying the transaction with the at least one server including matching the pin number. In yet another embodiment, the system further comprises a step of transmitting customer validation data to the plurality of merchants and generating in response to the step of verifying a request of customer verification from the plurality of merchants.

### BRIEF DESCRIPTION OF THE SEVERAL VIEWS OF THE DRAWINGS

Other features and advantages of the present invention will become apparent when the following detailed description is read in conjunction with the accompanying drawings, in which:

FIG. 1 is a system diagram of a card less and ATM-less money withdraw/deposit according to an embodiment of the present invention.

FIG. 2 is a system diagram of a card less and ATM-less money withdraw/deposit according to an embodiment of the present invention.

FIG. 3 is a flow diagram illus rating a single merchant registration according to an embodiment of the present invention.

FIG. 4 is a flow diagram illus large merchant registration franchise based merchant registration according to are embodiment of the present invention.

FIG. 5 is a flow diagram illustrating a user registration according to an embodiment of the present invention.

FIG. 6 is a flow diagram illustrating authentication registration according to an embodiment of the present invention.

FIG. 7 is a flow diagram illustrating a merchant adding authorized store franchiser adding the authorized store according to an embodiment of the present invention.

FIG. 8 is a flow diagram illustrating a merchant verification process to an embodiment of the present invention.

FIG. 9 is a flow diagram illustrating a customer payment/transaction selection from Internet based devices to an embodiment of the present invention.

FIG. 10 is a flow diagram illustrating a customer payment/transaction selection from Internet based devices to an embodiment of the present invention.

FIG. 11 is a flow diagram illustrating a security key validation process to an embodiment of the present invention.

FIG. 12 is a flow diagram illustrating a customer payment/transaction type selection from a smart device using GPS to an embodiment of the present invention.

FIG. 13 is a flow diagram illustrating a visiting the merchant to initiate/complete the transaction to an embodiment of the present invention.

### DETAILED DESCRIPTION OF THE PREFERRED EMBODIMENT

The following description is provided to enable any person skilled in the art to make and use the invention and sets forth the best modes contemplated by the inventors of carrying out their invention. Various modifications, however, will remain readily apparent to those skilled in the art, since the general principles of the present invention have been defined herein to specifically provide a card less and ATM-less money withdraw/deposit for consumers to withdraw and deposit cash at in locations irrespective to a bank or ATM location.

The solution is going resolve all the above stated (Background). Also the primary goal of the solution is to give a benefit to the customers as well as to the banks. Customers are no more worry to look for the nearest ATM available and also not to worry about carrying the banking cards to get the money.

The embodiments described herein are relate to the customer(s) who have device(s) which can access interact in any form (Wi-Fi, Cellular, WAN, LAN etc. of any form) or carrying a non-smart phone or the customers who doesn't carry any phone in order to authorize the with draw and deposit.

Now a days almost everyone owns a mobile or tablet or any PDA device with or without internet access. Here we are trying to use this as a source or replacement of the credit card.

The following system is the one which can be used to resolve all the above stated issues and also gives a solution for many more. The system is beneficial for merchants/sellers, customers/account holders as well as bankers. The primary goal of this system is, customers need not carry their credit/debit/ATM cards.

The embodiments described herein are relate to the customer(s) who have device(s) which can access hamlet in any form (Wi-Fi, Cellular, WAN, LAN etc. of any form) or carrying a non-smart phone or the customers who doesn't carry any phone in order to authorize the cash with drawl/deposits.

Now a days almost everyone owns a mobile or tablet or any PDA device with or without internet access. Here we are trying to use this as a source or replacement of the cards (Credit/Debit/ATM or any form of cards). Initially the user/customer/account holder will have an account in this system with all the required credit cards, gill, cards, debit cards, ATM cards and all other valid cards which can be used through this system. Also here the user is going to provide and activate the list of devices which can be used as part authorization.

This system is called as ATM-less Cash Management Authorization System (ALCMAS). When the customer/user/bank account holder need to with draw deposit the money, the user is not necessarily look for the nearest ATM/bank branch. Customer will find the nearest participated merchant to perform cash management for his account. After finding the merchant user will select the bank account with desired amount to deposit/with draw. This process can be done using Smart phone/Telephone/SMS/Toll free number/specified telephone number assigned for ALCMAS or using any other format. As soon as the system ALCMAS recognizes the customer it validates the merchant and customer.

Now the system will receives a message from the customer device/phone or designated system with customer requested information. ALCMAS is now interacts with the merchant more money availability and other stuff. ALCMAS will send a message with confirmation/failure or with other options to the customer. The money can be picked at any time to with the merchant by presenting the confirmation code to the merchant.

Merchant may verify the customer using various ways like Photo/Signature/any Bio-metric based authentications/non-biometric authentications or combination of any.

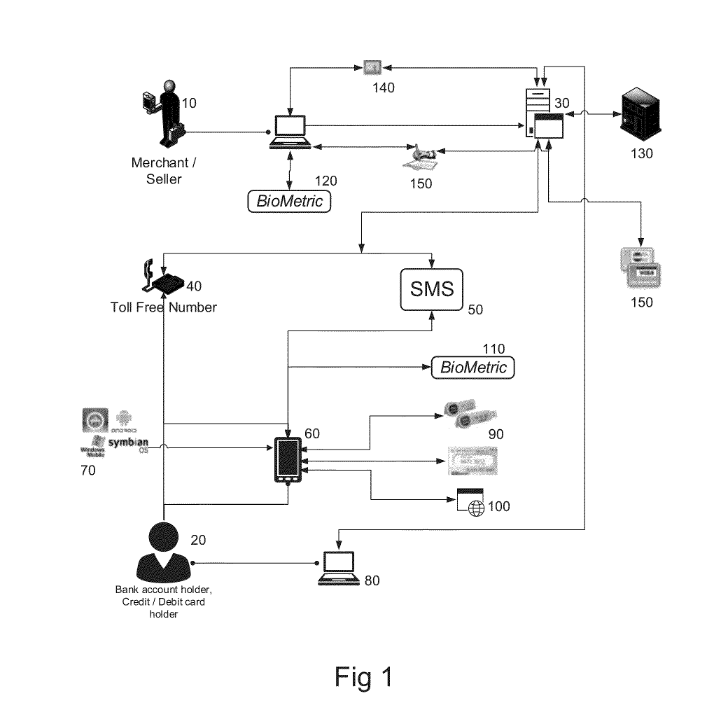

FIG. 1 is a system diagram of a card less and ATM-less money withdraw/deposit according to an embodiment of the present invention. The following is a description for element numbers listed in FIG. 1:

10: This represents the seller/merchant, is the one who is already registered for the ALCMAS (ATM-less cash management authorization system) and can be recognized with merchant ID.

20: This represents the bank account holder/credit card user customer, is the one who is already have an account within the ALCMAS, to authorize the transactions.

30: This represents the ALCMAS, which will do all the communications, authorizations etc., for both customer and merchant or in between customer, merchant, bank which holds the customer account or a similar kind of system.

40: The toll free number is the system which will be useful for all the customers who is willing withdraw/deposit the money by authorizing their transactions using the phone system. This will be useful for both the customers who is having phone and who doesn't carry phone. It also supports the voice recognition system of the user, which means only authorized user can authenticate the transaction.

50: The SMS based authorization system will be useful for the customers who carries a non-smart phone.

60: This is the device which is authorized by the customer. It can be any, which can access the interact with any format.

70: This is the application developed by the service provider to access the system from any of the customer registered/pre-registered devices.

80: This represents the computer which is pre-registered by the customer to do the transaction authorizations. This device will also be considered under step 60. The computer can also be a public computer or might be a non-registered computer.

90: This system is the RSA key system which will be used to authorize the customer transactions for a trusted authentication system.

100: This system represents all other software or hardware or both which are similar to the RSA system developed anyone. It also includes the SMARTCARD and related security systems.

110: This is the system which is again an extra security system to authorize by the customer. These are either internally or externally connected BIO-Metric devices with the customer registered devices. It includes all types of BIO-Metric devices, face recognition system, Digital Signature devices or applications etc.

120: This is the BIO-Matric device which is connected to the merchants billing system, and is used by the customer to authorize it. It includes all types of BIO-Metric devices, face recognition system, Digital Signature devices or applications etc.

140: This is another secured validation system for both Merchant and Customer. This sends the Customer/Buyer photo image which is stored and validated at central server to the merchant, to verify the customer is right person or not.

150: There are sonic situations where customer can't be recognized with photo (Like in Arabic countries). At these locations the signature can be used as an alternative authorization.

Still referring to FIG. 1, the flexible rod is made from a flexible material, including but not limited to fiberglass, allowing the apparatus to bend in any direction, i.e. 360 degrees. For instance, when using the apparatus the flexible rod enables the user to stand at normal height and insert the apparatus through the underside of the pallet from any angle or position. This is advantageous, as the user doesn't need bend lower to use the apparatus, preventing potential back injury or pain.

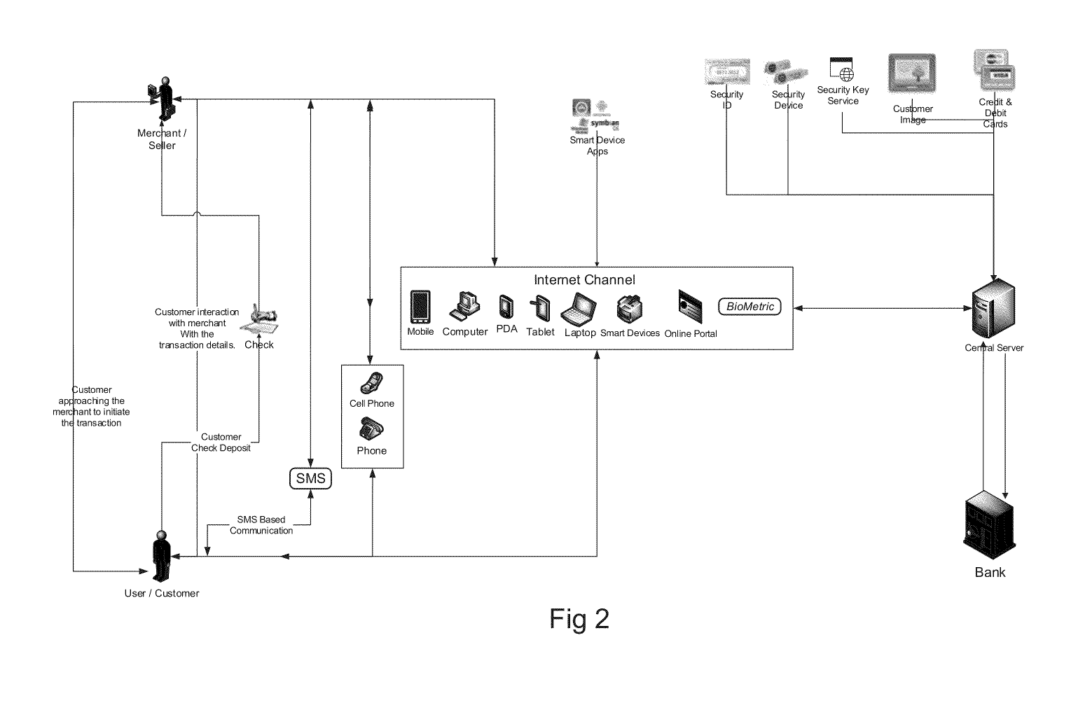

FIG. 2 is a system diagram of a card less and ATM-less money withdraw/deposit according to an embodiment of the present invention. User/Customer: Represents the person who is intended to withdraw from the account or deposit into the account. Here customer can use any one or combination of the ways to withdraw or to deposit the money to the account with the help of the merchant. As depicted in the drawing customer may choose to use any one or combination of the process like Check, SMS based, Voice based, internet based etc. Merchant/Seller: Represents the entity and or a person who will be performing the operations in place an ATM (Providing cash to the customers/accepting depositing the money from the customers etc.)

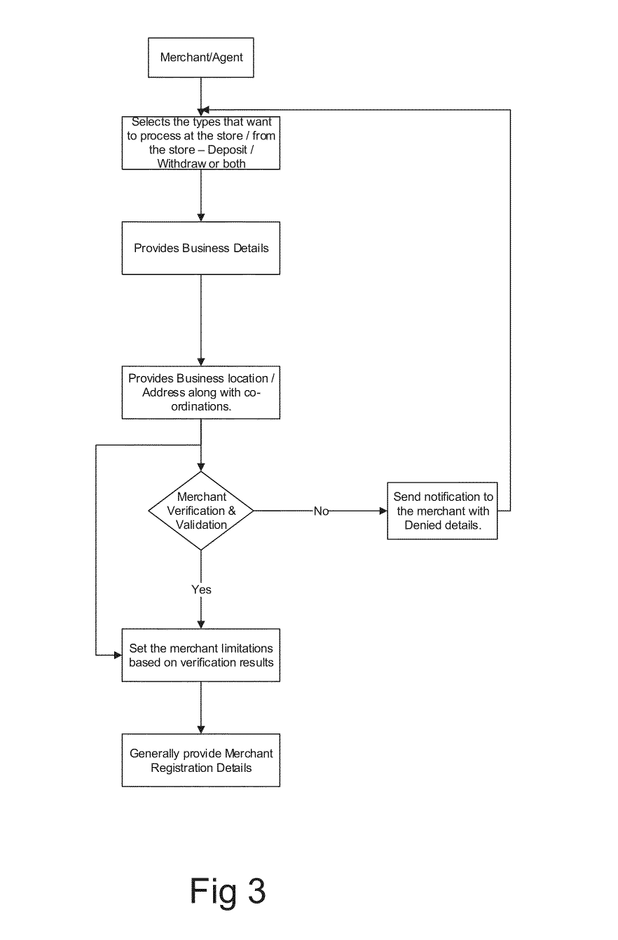

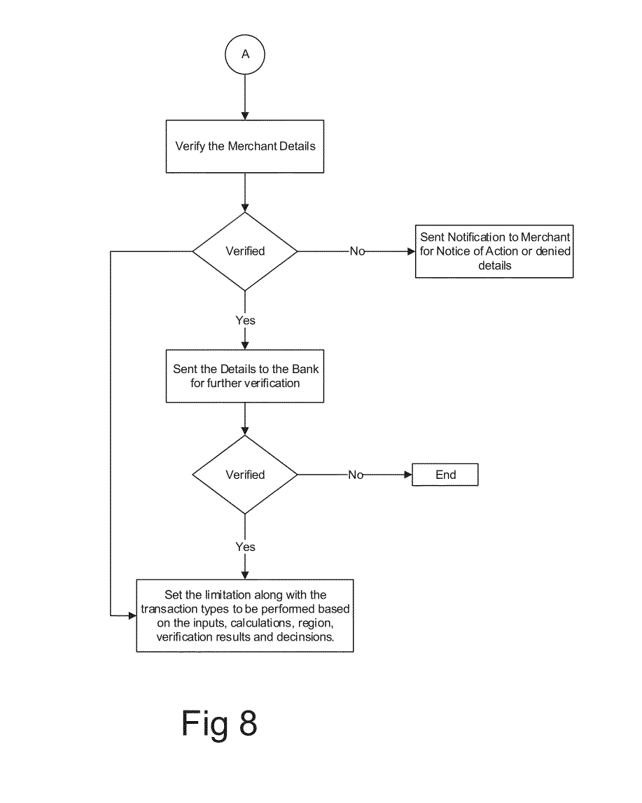

FIG. 3 is a flow diagram illustrating a single merchant registration according to an embodiment of the present invention. The merchant information should be available with the system If a merchant wants to participate/decided to additional revenue with the system. The merchants can be of any size like pan shop to a large scale merchant. The details of the merchant will be validated in order to approve to accept the requests from the users. The merchant can have limitations on the transactions types and or amounts. It can unlimited if the merchant is a potential. Merchant will be notified with the decision once validated. The verification process follows in FIG. 8. Finally, the merchant is provided with a unique id (sometimes after the verification and validation process where it is applicable).

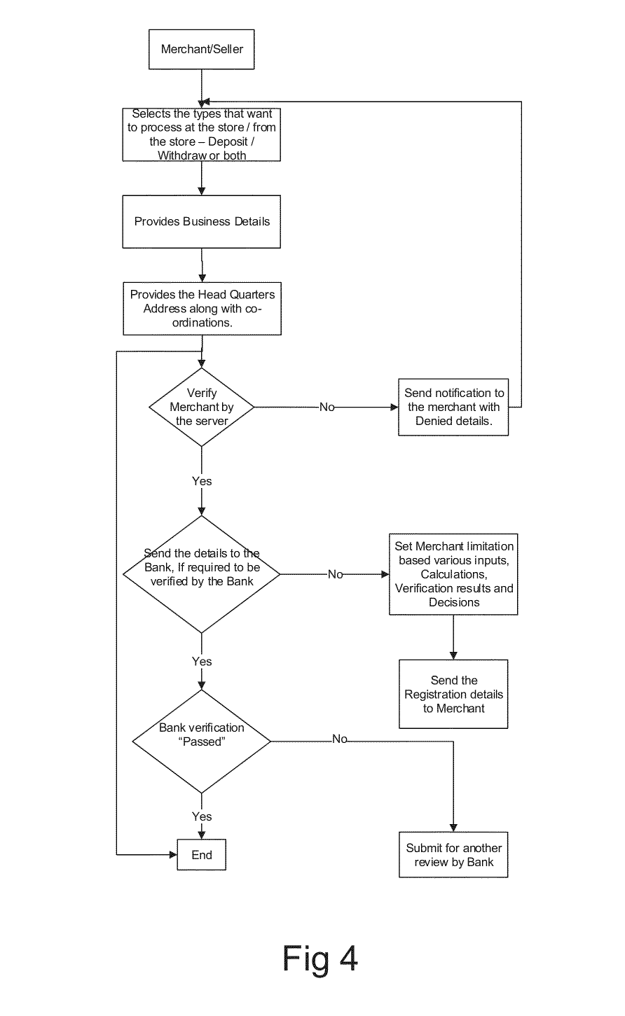

FIG. 4 is a flow diagram illustrating a large merchant registration franchise based merchant registration according to an embodiment of the present invention. Large/Franchise based Merchant are chain of branches or the merchants who has multiple locations of their business like Target, Sunoco etc. of any kind and or any size. The merchant validation process is equal to all which follows as in the FIG. 8. The verification process by the server includes the process of FIG. 8. The limitations would be set by bank and or the system based on the results of the verification process.

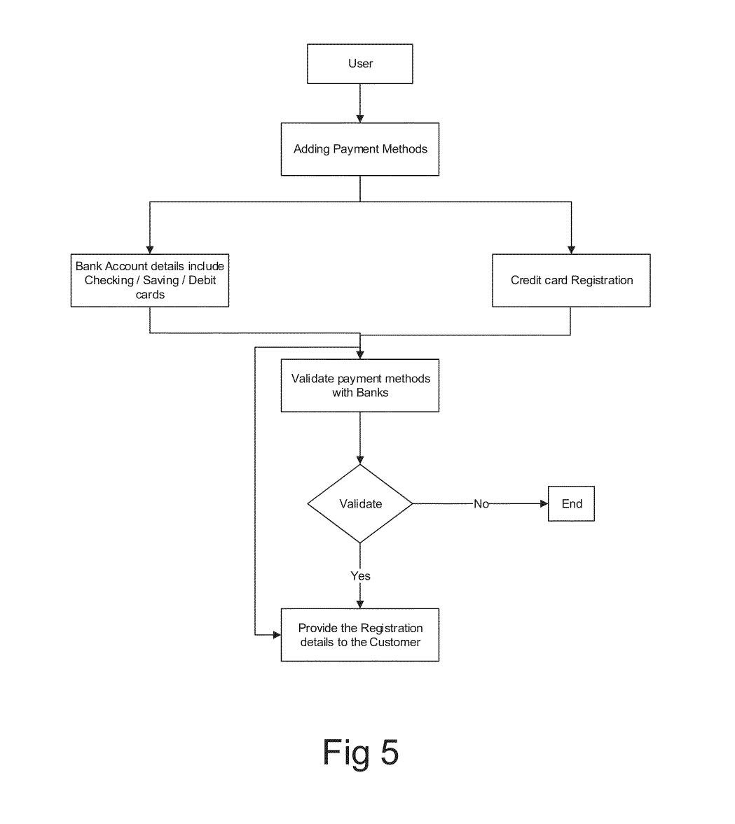

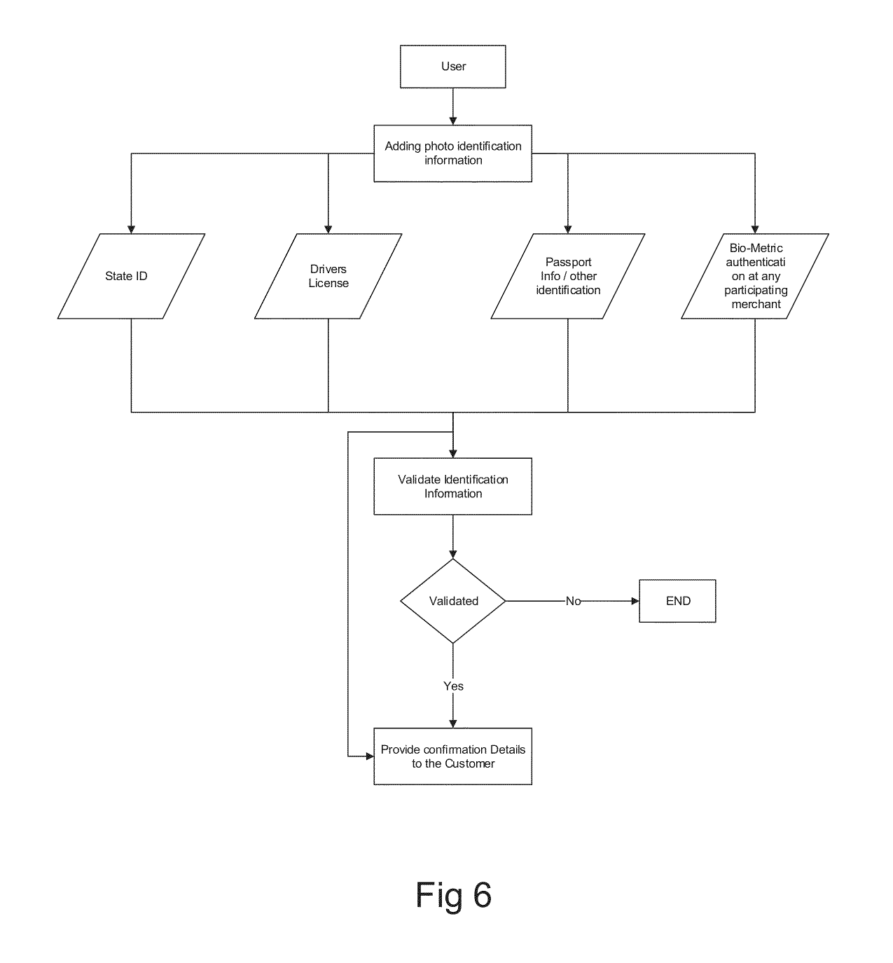

FIG. 5 is a flow diagram illustrating a user registration according to an embodiment of the present invention. The user/customer is required to register with the system in order to recognize and provide the services from the system and or perform transaction with the participating merchant. The system is going through the process of verification for the customer as shown in FIG. 6. The details required might be different or same like merchant depending on the customer and merchant. User can be able to add various payment methods. The payment methods can be of any type as including but not limited to Personal checking, personal savings, business checking, business saving, credit cards, debit cards and or any type of accounts which can be used to make the money transactions. The accounts will also be validated by the system.

FIG. 6 is a flow diagram illustrating a user authentication registration according to an embodiment of the present invention. The user/customer has to be registered with the system in order get the benefits ATM-less and Card Less system. During the registration process the system may ask the user to provide some identification details for verification and validation process. It is not necessary in every user. The system also might ask the user to provide the Bio-Metric based details for additional validation with some merchants where ever it is possible. In some cases, the customer may not be eligible to use the system if not validated. The validation process involves verification results from one and or many like banks, credit history reports, third party verification vendors, government etc.

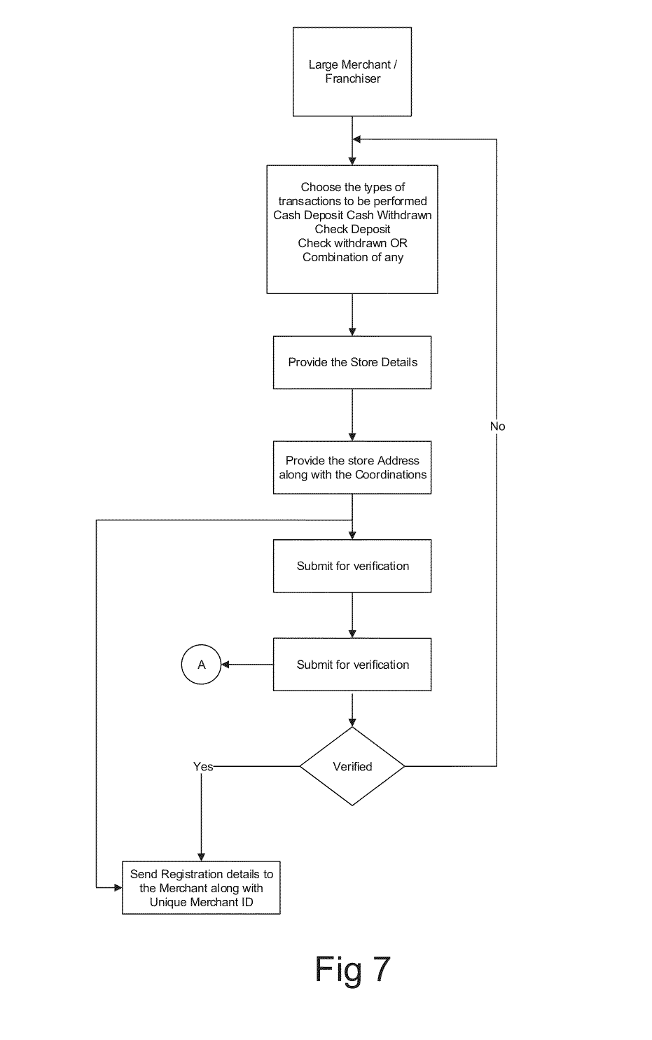

FIG. 7 is a flow diagram illustrating a large merchant adding authorized store franchiser adding the authorized store according to an embodiment of the present invention. Large scale merchants can be able to add a franchise eligibility to use the system. The primary merchant can add the franchise along with the type of transactions eligible to perform with any combination or all. Merchant can be able to place a request remove/cancel the franchise from this service. Even though the merchant is able to add the franchise, it may be required to go for verification process of the franchise details. Again the verification is not necessary and differs for every customer and or every franchise and or location. Sometimes it may also depend on the transaction types. The merchant/franchise verification process follows in FIG. 8.

FIG. 8 is a flow diagram illustrating a merchant verification process to an embodiment of the present invention. The merchant verification process is to validate the merchant in order use the system. As said above it is not necessary in all the cases to go through the process for the merchant. To validate the merchant, it is required to provide including but not limited to the merchant business type, type of transaction interested in. Also the merchant details will be sent to the bank to verify further more if it is necessary which means it is not mandatory to all. It may vary from merchant to merchant, bank to bank etc. Finally, the merchant limitation will be set (depending upon the verification results in some cases).

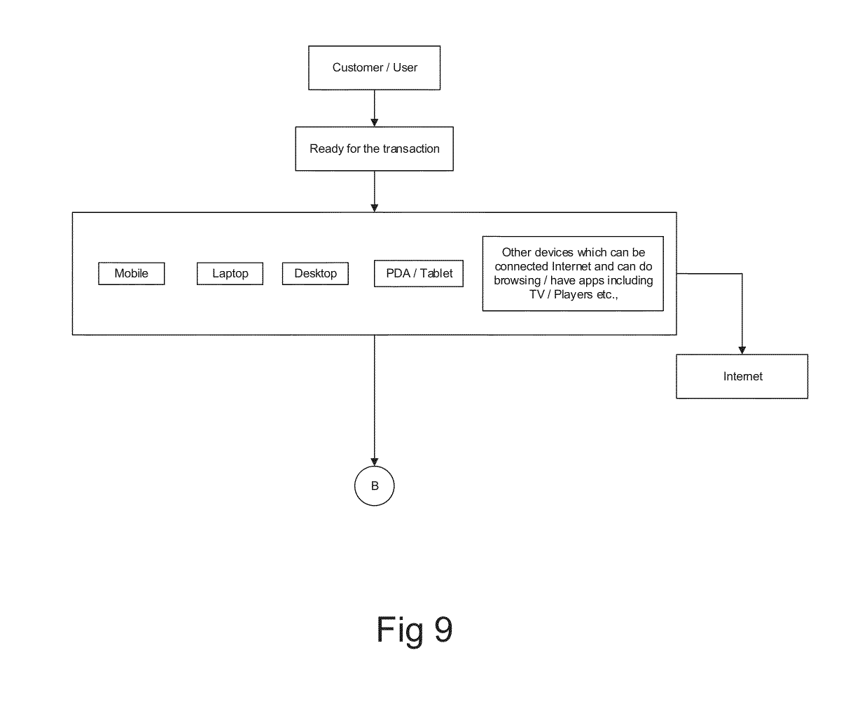

FIG. 9 is a flow diagram illustrating a customer payment/transaction selection from Internet based devices to an embodiment of the present invention. This diagram depicts how the transaction can be performed/initiated from the internet enabled devices. Customer selects the device from which the transaction to be initiated. Customer can give extra security by registering the devices like computer, mobile, tablet etc. The transaction can be initiated either using the web page or by using the mobile application (iOS, Android, Microsoft, Blackberry etc. smart enabled mobile devices).

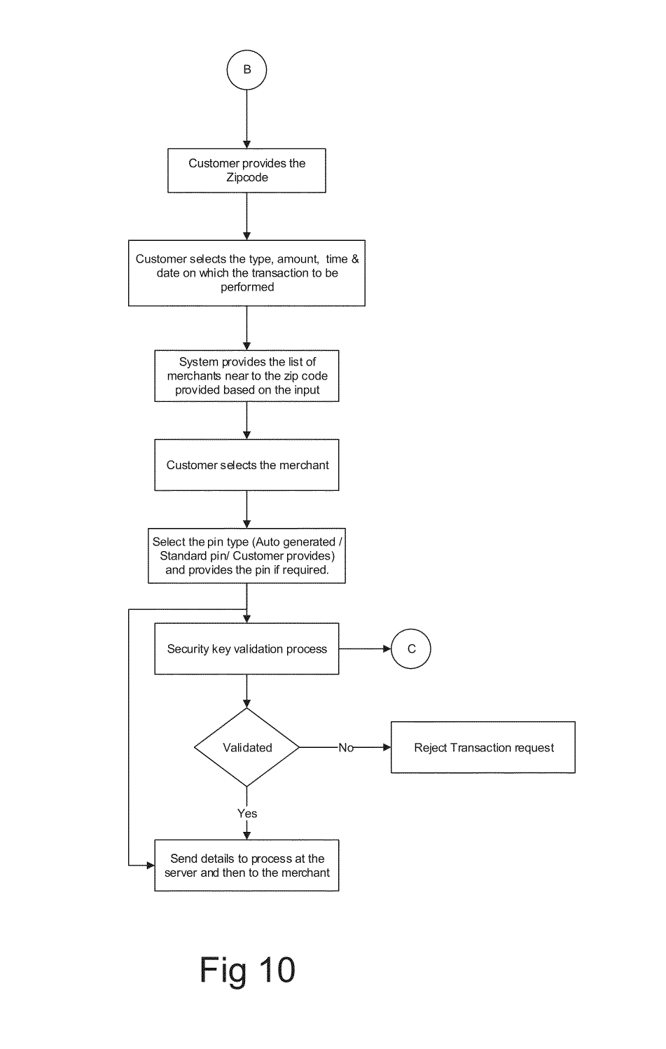

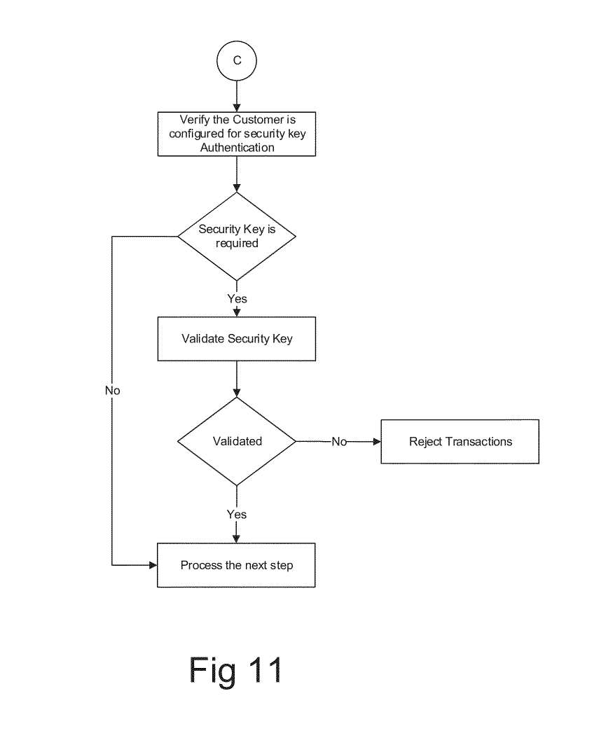

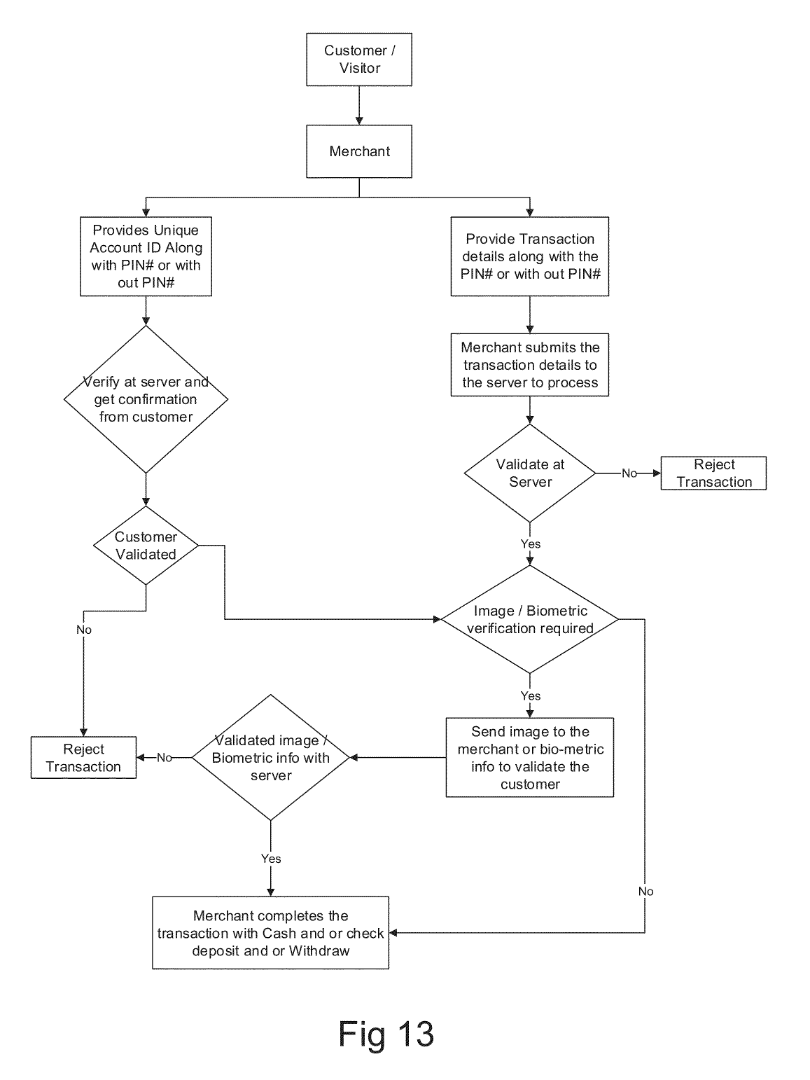

FIG. 10 is a flow diagram illustrating a customer payment/transaction selection from Internet based devices to an embodiment of the present invention. Customer will search for the nearby participating merchants from where the transaction to be performed either by providing the zip code or the GPS location along with the date and time of the transaction to be performed, transaction type and possible with amount. All these details are accepted possible with one or combination of all. Now the system allows the customer o select the desired merchant from the list based on the inputs provided. At this point customer will confirm the transaction details. Also the system validates the transaction request against the security key process if it preset and permitted whenever possible. The validation details will be further discussed in FIG. 11. Further how the customer completes the transaction is discussed in FIG. 13.

FIG. 11 is a flow diagram illustrating a security key validation process to an embodiment of the present invention. Security key validation process is an extra security layer process which will validate the transaction details with the device from which it received the information. This entire process is application only if the customer has the ability to use the validation process. This security key process is validation process works as follows: the transaction details are associated with unique one-time key which is generated by the server. The server validates this key when it receives the transaction details.

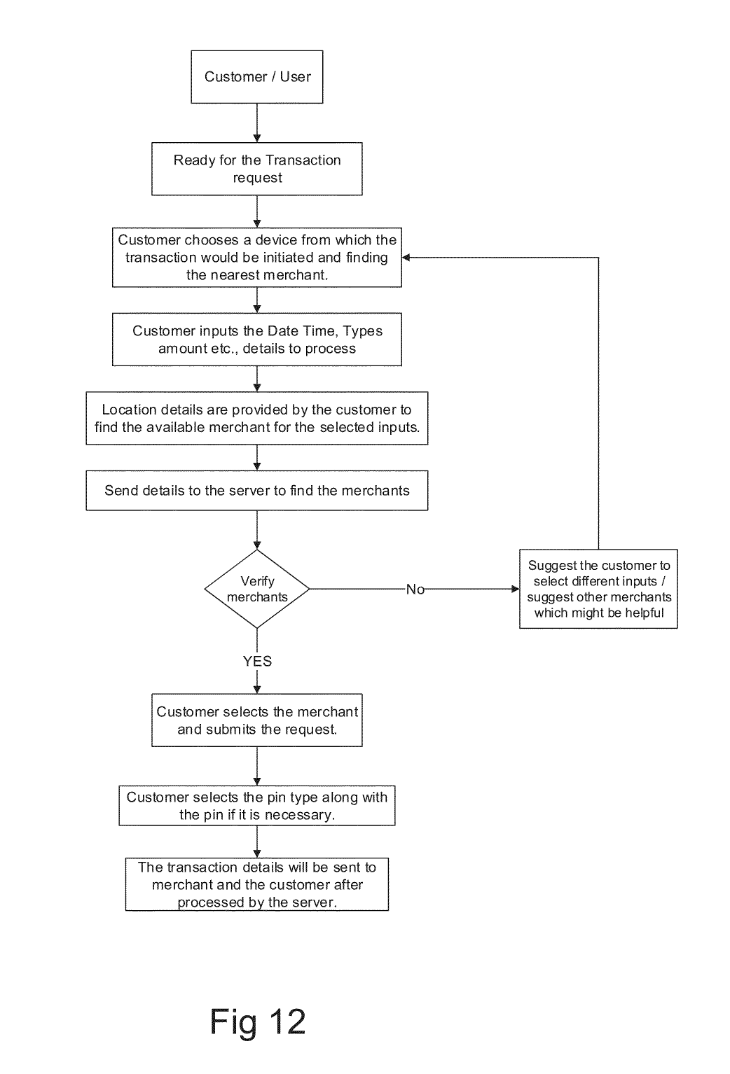

FIG. 12 is a flow diagram illustrating a customer payment/transaction type selection from a smart device using GPS to an embodiment of the present invention. Customer provides the type of the transaction to be performed, time of the transaction, amount etc. details to the server along with the desired GPS location to find the nearest participating and available merchants who are eligible with the conditions provided. The system also finds the merchant based on the operating times, available money to perform the transaction etc. where ever it is possible. The transaction will be ready to complete when customer decides to proceed with the desired transaction. Here customers can also another security pin for the transaction. This can be for each transaction or a master key for all the transactions. This pin can be used when the transaction to be completed by the customer at merchant location to avoid the fraudulent activities. The pin security is totally optional for the customers and their transactions.

FIG. 13 is a flow diagram illustrating a visiting the merchant to initiate/complete the transaction to an embodiment of the present invention. As soon as customer gets the confirmation details of the transaction to be performed, customer approaches the merchant. Customer provides the transaction id along with the other details to the merchant for completing the transaction. Now merchant verifies transaction and ask the customer to provide the PIN number where it is necessary and applied. Now the merchant can also validate the customer by asking the ID proof's etc. where it is application. Also the merchant can request the customer to validate against the Bio-metric authentication. Merchant completes the transaction after the customer is validated or if no validation is required.

1-3. (canceled)

4. An ATM-less cash management authorization system comprising:
at least one server comprising a plurality of customers, a plurality of merchants and a plurality of banks;
the plurality of customers including a customer profile for each customer, the customer profile comprising a payment account data and at least one corresponding verified customer image, and at least one corresponding device to securely authenticate payment;
the payment account data comprising a east one payment card and at least one bank account associated with a pin number;
the at least one server configured to execute a payment authorization module and an authentication module comprises the following: receiving a request to authorize the transaction from the at least one payment card and at least one bank account of the plurality of customers to the plurality of merchants.

5. The ATM-less cash management authorization system of claim 4, wherein the at least one server configured to execute a payment authorization module and an authentication module comprises the following: initiating a request to authorize the transaction from the at least one payment card and at least one bank account of the plurality of customers to the plurality of merchants, wherein the request may include a pin number based on a set of preferences of the plurality of customers.

6. The ATM-less cash management authorization system of claim 5, further comprising a step of verifying the transaction with the at least one server including matching the pin number.

7. The ATM-less cash management authorization system of claim 6, further comprising a step of transmitting customer validation data to the plurality of merchants and generating in response to the step of verifying a request of customer verification from the plurality of merchants.
